(19) United States
(12) Patent Application Publication
(10) Pub. No.: US 2006/0149627 A1
(43) Pub. Date: Jul. 6, 2006

(54) Electronic discount and rebate coupon system

(76) Inventor: Collie D. Brown, Mount Vernon, NY (US)

Correspondence Address: COLLIE D. BROWN, 206 North Columbus Ave, Mount Vernon, NY, 10552, US

(21) Appl. No.: 11/028,393

(22) Filed: Jan. 3, 2005

(51) Int. Cl. G06Q 30/00

(52) U.S. Cl. 705/14

(57) ABSTRACT

A system that allows multiple discount and other coupon issuers to create and issuer electronic coupons to recipients on a single coupon card the recipient has. The coupon recipients benefit by not having to carry around one card for each coupon issuer, in addition, the recipient can access one coupon account online to see the entire available coupons on their card.

### CROSS-REFERENCE TO RELATED APPLICATIONS

Not applicable.

### BACKGROUND--FIELD OF INVENTION

This invention relates to offering electronic discount and rebate coupons that are distributed over public and private computer networks.

### BACKGROUND OF THE INVENTION

In recent times manufactures and product distributors of name brand goods or services have watched as retail outlets have slowly eaten into their product market share with store brand goods. Some examples of stores and their brands are COSTCO with their Kirkland brand, Albertsons with Albertsons brand, and WAL-MART with OL'Roy brand. In addition to producing their own store brands, stores have a big impact on the rate at which items are sold since they control the placement of goods in their store. An additional advantage store brands have over national brands is pricing. Stores do not have to pay for huge marketing campaigns and outside distribution companies when dealing with their own brands. It is common practice for manufactures and distributors to pay stores to place their products in prominent locations within a store, which adds to the cost of an item.

According to a recent article in the Aug. 11, 2003 Edition of Fortune magazine, “one in five items sold in US stores is store branded”. And this trend is increasing. To counter this trend manufactures have little ammunition. Brand awareness is becoming more difficult to maintain because of the proliferation of media outlets. There are over 200+ television channels and large numbers of print media to cover in order to get your brand name before US households. In the past, the major networks would be able to reach the majority of US households; this made it simple for manufacturers to develop national brand awareness. To compound matters, manufactures rely on antiquated paper clip coupons that are either attached to a product's packaging or inserted in a newspaper. Customers are required to cut out these paper coupons and present them to the store to receive the discount. This latter method is very costly and time consuming. Most shopping is done on the spur of the moment and customers often forget the coupons when they go to the store. Additional reasons why paper clip coupons are not the best way to reach customers are
1) Coordinating a marketing campaign requires the cooperation of large numbers of individuals and organizations (manufactures, packaging companies, printers, newspapers, and stores).
2) Advance planning must be done which can take weeks and sometimes months to arrange printing.
3) If the coupon is included on the product's package, packaging has to be printed and shipped to the packing plant, which takes time and additional expense.
4) Newspapers must print, insert and distribute the coupons with their regular paper, which is also expensive.
5) The salaries of store and manufacturer/distributor employees' who handle the clipped coupons increase the marketing expense.
6) Manufactures and distributors do not get much immediate feed back from the customers since a coupon is not associated with a specific customer which may prevents them from making needed corrections during a promotion.
7) A company commits large amounts of money upfront before they know whether or not a camping is going to be successful.

Other existing discount systems such as store discount systems exist but even though these systems may utilize some form electronic transmission also provides their customers (members) barcode key tags or other account identifying devices, these systems are proprietary and have major deficiencies. The first major deficiency of these systems is that they are designed for single store or at chain stores use. Second, these systems are designed to increase traffic and therefore sales at a store or chain or for increasing the sales of items that are not moving as they should. Third, manufacturers and distributors of national brands do not directly control these promotions, they cannot directly issue discounts to potential buyers of their products through these systems. The fourth major deficiency is that manufacturers and distributors of none store brand goods do not get immediate feedback when a customer purchases their product, this information belongs exclusively to the store and it is jealously guarded. There are other serious deficiencies that are too numerous to list here.

The electronic discount coupon system of this invention provides an easy and convenient means for customers to take direct advantage of manufacturers discount coupons. Manufacturers and distributors are provided a quick, easy and convenient means of influencing a customers' buying habits through the use of this inventions electronic discount coupon system.

This invention provides a new and unique way for manufacturers, distributors, or entities wishing to offer discounts directly to their customers, a convenient central system where they can issue and redeem electronic discount coupons. Customers holding electronic discount cards connected to this system's central repository are able to take advantage of the electronic discounts coupons at multiple chain and independent store locations. Through the use of public networks such as the Internet as well as private ones, this invention provides a link from stores to the central electronic discount coupon repository and to the manufacturers and distributors. This electronic coupon system can be easily integrated into their ongoing advertisement campaign at little or no extra cost.

In addition, the electronic coupon of this invention can be used in place of rebate coupon, it is explained by the following example. Two manufacturers A and B both manufacture the televisions similar features and at a base price of $117.00. Both A and B offer a $17 mail in rebate coupon. Company A also provides a $15.00 electronic discount coupon that can be used in place of its $17.00 rebate. The customer now has the option of choosing the immediate discount of $15 or risks the loosing the $17 by forgetting to mail in the rebate coupon, which often happens. If the customer chooses the discount, company A receives a premium of $2 on the television purchased. Company B is at a disadvantage sine many customers now realize they are unlikely to mail in the coupon and will eventually loose the $17 rebate.

Customers with this inventions electronic discount card can manage their accounts or request coupons via phone or the Internet or any other convenient means. Currently, store discount cards are restricted to the discounts offered by that store or chain. Generally, manufacturers and distributors rely on the stores to run store card promotions.

### SUMMARY

It is an object of this invention to create electronic discount coupon system that provides a way for multiple manufacturers to use a single discount system to influence the buying habits of their customers.

A customer through the use of one electronic discount card is able to take advantage of discounts from multiple issuers at multiple chain and independent store locations. Current store discount cards are restricted to the discounts offered by the store or chain, it also forces manufacturers and distributors to still rely on these stores to run promotions on their behalf.

It is also a further object of this invention to provide a central repository where customers with the discount card of this invention can manage their accounts via phone or the Internet or any other convenient means. Customers can request coupons and see what coupons are available on their card, etc.

### OBJECTS AND ADVANTAGES

Accordingly, beside the objects and advantages of the electronic discount coupon described in the above patent application description, several objects and advantages are
a) to provide manufacturers and distributors the means to directly influence customers purchasers by being able to quickly offer customers discounts through the electronic coupons on a discount card;
b) to provide manufacturers and distributors of national brands the means to counter the prevailing belief that that store brand items are less expensive than national brands since a national brand with a discount coupon may be less expensive;
c) to provide manufacturers and distributors access to the electronic discount coupon systems ahead of time thereby removing the need for the discount issuers to have to continually conduct a full scale planning for every new promotion;
d) to provide manufacturers and distributors the means to distribute large amounts of coupons to potential customers within a very short time period since it is done electronically;
e) to reduce the cost of processing discount coupons by processing it electronically instead of by expensive manual labor;
f) to provide additional customer feedback data along with the redeemed coupons to the issuer thereby allowing the issuer to develop a customer profile which can be used in future targeted promotions;
g) to provide a means where card holders can request discount coupons form individual issuers, the issuer taking advantage of the speed and ease of use of this inventions, can create and distribute a custom coupon for that individual customer in very short time;
h) to provide near real time updates, usually less than an hour to the manufacture/distributor on the rate at which discounted items are being sold, thereby giving critical information to the manufacturer/distributor so that they can adjust ongoing marketing campaigns;
i) to provide a central repository where holders of the discount card can view and manage their coupon account containing coupons from issuers.
j) to provide a means where a coupon issuer can cancel or replace existing unused coupons;
k) to provide central media outlets such as a television channel, website and or radio stations that is dedicated to publicizing and informing the public about the electronic discount systems and its discount coupons that are available.

Further objects and advantages are the reduced cost of creating new marketing campaigns and reducing the cost of unused coupons. Taking advantage of most existing computer networks including the Internet will further reduce the implementation cost. Further objects and advantages will become apparent from a consideration of the ensuing descriptions and drawings.

### DRAWINGS FIGURES

FIG. 1A shows the process of generating and distributing electronic discount coupons to customers discount card accounts.

FIG. 1B shows a discount card owner requesting a custom discount coupon and the coupon being generated by distributed by a manufacturer/distributor to card owner's account.

FIG. 2 shows a customer redeeming an electronic discount coupon for goods and services at a store and the redeemed coupon being sent to the issuer. The matching of the coupons to items purchased is done on the client software residing at the store.

FIG. 3 shows a customer redeeming an electronic discount coupon for goods and services at a store and the redeemed coupon being sent to the issuer. The matching of the coupon to items purchased is done at the coupon-processing center.

### REFERENCE NUMERALS IN DRAWINGS

1 customer holding the discount coupon card

5 coupon certificate processing software that resides at the store

7 manufacturers or distributors that are creating the coupons

8 list of all coupons on the customer's discount card

9 list of discounted items being sent back to the store to be added to customers shopping list total

10 coupon-processing center, which manages all customers' coupons and coupon discount request

11 barcodes of items purchased by the customer being sent to the coupon-processing center

12 list of coupons that have been used by the customer

30 customer database at the coupon-processing center where all customers' coupons are stored

### DETAILED DESCRIPTION OF THE PREFERRED EMBODIMENTS

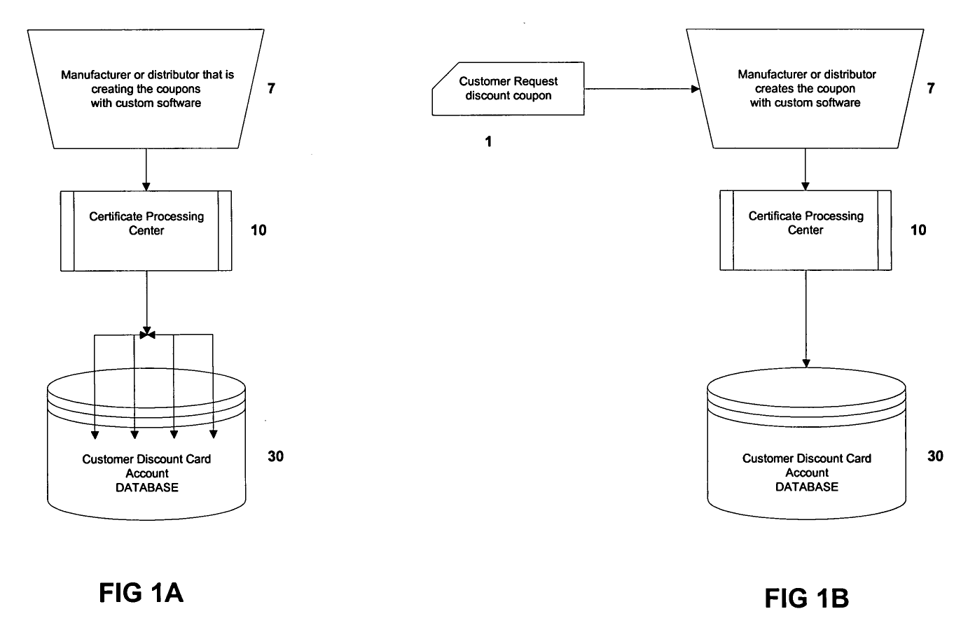

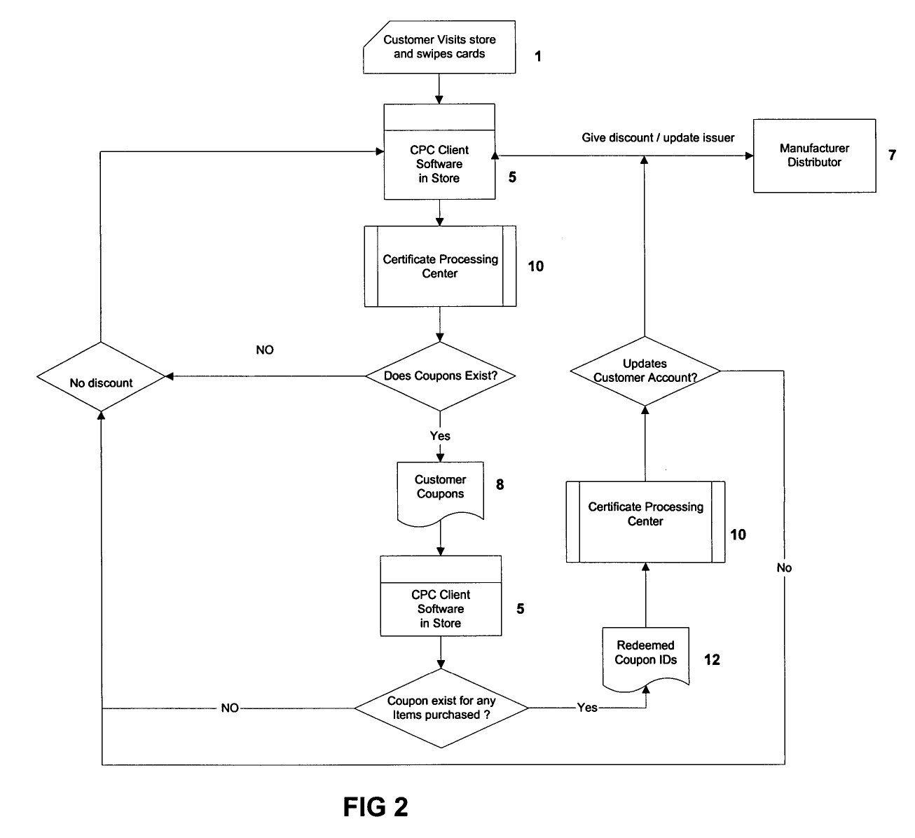

A preferred embodiment of the discount processing system is illustrated in FIG. 1A, 1B and FIG. 2. FIG. 1A shows a manufacturer or distributor 7 creating discount coupons. The coupons are uploaded to the coupon-processing center 10 where they are inserted into the customers' discount accounts 30, ready to be used by that customer. FIG. 2 shows a customer 1 using his or her discount card to shop at a local store. The card is swiped or scanned in using a barcode reader or any suitable means of retrieving the card number. Once the discount card number is identified it is passed to the coupon processing software 5 residing at the store. The coupon processing software submits the card number to the coupon-processing center 10 where a list of the discount coupons on the customer's card 8 is returned. The coupon processing software 5 cross checks the coupons against the items purchased 11, If a match is found, the software 5 send the list 12 to the coupon-processing center where the matched coupons are marked as used in the customers account. The coupon-processing center 10 sends the acknowledgement back to the client software 5 at the store and the customer is given the discount. If no match were found no discount would be given to the customer 1.

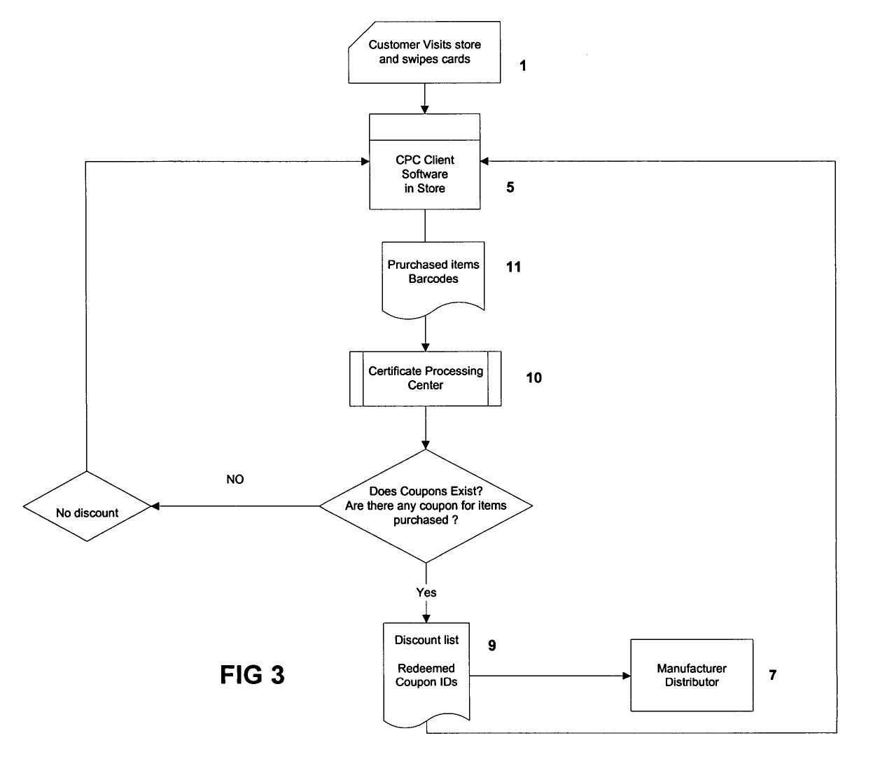

FIG. 3—Alternative Embodiment

There are various possibilities with regard to where the actual match between the items purchased and the coupons that exist for those items as illustrated in FIG. 3. It shows the barcodes of the purchased items being sent to the coupon-processing center 10 where the match is made. This embodiment reduces the number of interaction between the coupon processing software 5 at the store and the coupon-processing center 10

### ADVANTAGES

From the description above, a number of advantages of the electronic discount coupon become evident:
(a) By using electronic coupons manufacturers are directly influincing the customers decisions on what is purchased, manufacturers are reclaiming some of the influence that has been lost to retasil stores.
(b) The issuance of electronic discount coupons can be closely alligned with other marketing inatives and does not require large amounts of lead time and money as traditional paper discount coupons to prepare.
(c) Manufacturers and distributors receive current updates statuses on items being purchased with the discount card, this information can be used to adjust the marketing course of action or the amount of inventory keep, etc.
(d) Discount card customer can contact a manufacturer or distributor and request a coupons for an item they produce, even for items that may not be on sale for the general public; the manufacturer/distributor can create and distribute the coupon in minutes since it is all electronic.
(e) Manufacturers and distributors can create custom coupons for specific customers using their previous buying patters as a guide.
(f) The cost and time involved in creating and processing electronic discount coupons is less that of existing paper coupons, no more manul processing of coupons by store and manufacturer employees.
(g) Customers do not have to cut out paper clip coupons anymore, the coupons are all on their discount card which results in higher usage.
(h) Manufacturrers do not have to rely on stores to promote sales, with this invention, the infrastructure is in place, all that has to be done is for the manufacturers and distributors to do is create and distribute the coupons.

Operation—FIGS. 1a,1b,2,3

Before the electronic coupon of this invention can be created a number of conditions must exist. The conditions are, first, the product manufacturer or distributor is provided access to the software that allows them to gather and submit the coupon data to the coupon-processing center (create coupon) 10. Second, the stores that will be processing the coupon must have access to the coupon processing software 5; this software resides at the store and cross checks coupon against the items purchased. Third, the coupon processing center 10 software where the coupons and managed must be accessible by all parties to the transaction. Fourth, customers 1 must be issued discount cards after subscribing over the Internet, US mail, or by telephone.

Now that the environment is set, the first order of business is for the manufacturer to create the coupon. Using the software provided 7, the manufacturer creates the coupons and specifies the coupon-receiving customers. A number of criteria for determining who receives a coupon such as a customers previous buying pattern, where the customer lives etc, may be used. The coupons are transmitted to the coupon-processing center, where they are added to the customers' accounts 30. When a coupon is added to a customer's account he or she may be notified. Notification can be by email or telephone text messages, or any other suitable notification means.

This next step explains how a customer redeems a coupon. A customer goes to a store to shop; at the checkout counter the customer's discount card is swiped or scanned by a card reader. The discount card number and the barcodes of the items purchased are then sent to the coupon processing software (CPS) running on the stores computer. The CPS using the card number submits a request for all the discount coupons for this card. If no coupons exist the CPS returns to cash register software that fact and informs the coupon-processing center to close any opened transaction. If coupons exist, the CPS cross checks the coupons against the items purchased. If matches are found, the CPS sends a list of the coupons to the coupon-processing center and to the cash register software. The cash register software prints the discount on the customer's bill and deducts the value of each coupon from the customer's total.

The final step is to reimburse the store for the cost of the coupons. Upon receiving the list of used coupons from the CPS, the coupon-processing center send the coupon data along with additional customer data and store information to the manufacturer (issuer). The manufacturer upon receiving this data reimburses the store for the cost of the coupon. The stores and the manufacturers determine the frequency of reimbursements. The manufacturers can also used the data provided by the coupon-processing center in future marketing initiatives.

### CONCLUSION, RAMIFICATIONS AND SCOPE

Accordingly, the reader will see that our electronic discount coupon is much more cost effective to use than traditional paper clip coupons. It has additional advantages in that
Issuers can create and distribute electronic discount coupons in less of the time than traditional paper clip coupon;
It is more difficult for customers with the electronic discount card to assume store brand goods cost less than national brands since a national brand with a discount coupon me be less expensive. This increased the likelyhood of a customer purchasing a nation brand product;
Marketing campeigns using electronic discount coupons can be easily recalled or adjusted if it is not providing the expected results by simply cancelling or replacing all the unused discount coupons. This can be done with very little effort and is very difficult to do with paper coupons especially if there is a typographical error invloved;
Discount card members can request discounts on items that may not be on sale, a manufacturer or distributor can issue such coupons in very short time electronically, thereby allowing a customer that could have otherwise purchased a different product to purchase this issuers product at a discount;
Electronic discount coupons provides an attractive alternative to rebate coupons by offering the customer an instant reduction in price. This discounted price may be a slightly higher than the price minus the full rebate. Manufacturers expect to pay an average price that is between the price of the sales price minus the cost of the rebate and the sales price, the Electronic discount coupon value=(Full price−Average post rebate price). The incentive for accepting the discount instead of the rebate is the fact that the customer must pay the full price upfront and also runs the risk of not receiving the rebate if it is not mailed on time;

1) A method for one or more entities to create, distribute and redeem electronic coupons through an electronic coupon system comprising:
(a) an electronic coupon repository where said entities deposit electronic coupons they create;
(b) a means where said deposited coupons are distributed to various accounts of consumers who have subscribed to said coupon system
(c) Providing a means where consumers who subscribe to said electronic coupon system are assigned a coupon account at said coupon repository;
(d) providing a means for identifying said recipient account including barcode key tags or plastic credit card like devices or any other suitable account identifying device that can be read by machine or human;
(e) providing a means whereby said consumers may be notified by various means when coupons are deposited into their accounts including but not limited to email, direct mail, phone or website;
(f) said electronic coupons
1) include but not limited to the following uses, as discounts, rebates, and gift certificates, and
2) consists of data elements including the issuer, expiration date, monetary value, other data representing coupon terms and conditions;
(g) providing a means where said subscriber wishing to redeem said electronic coupons that are deposited in their account visits various entities including retail and online stores where said subscriber presents said identifying device to said redeeming entity thereby allowing said entities to identify and access the coupon account of said subscriber through various means to determine if there are any coupons that are redeemable and if there are said redeeming entity redeems the coupons
(h) providing a means where said coupon repository notifies coupon issuers through various means whenever said issuers coupons are redeemed such that said entities can use said notification to make any necessary adjustments to current or future electronic coupon campaigns
(i) said notification to said coupon issuers include information about the redeemer, the entity where said coupon was redeemed, date and time said coupon was redeemed or any other useful information to said issuers thereby allowing said entities to create electronic coupon campaigns by creating, distributing and redeeming said coupons electronically including quickly gather information about said coupons from the time said coupons are issued until said coupons have expired or are redeemed whereby said entities can use said information to make adjustments to ongoing or future electronic coupon campaigns.

2) The electronic coupon system of claim 1 wherein said electronic coupon issuers can make modifications to unredeemed coupons including canceling and or replacing said coupons as well as creating profiles of subscribers redeeming said coupons whereby said profiles are used as guides in current and or future electronic coupon campaigns.

3) The electronic coupon system of claim 1 wherein multiple coupon issuers do not need to compete for subscribers since all coupon issuers of said electronic coupon system have access to all subscribers of said coupon system whereby it is not necessary for said subscribers to have individual subscriptions to each issuers coupon system in order to receive coupons from said issuers.

4) The electronic coupon system of claim 1 wherein multiple electronic coupon systems may be combined into a single coupon system whereby consumers do not need to subscribe to multiple electronic coupon systems to receive coupons from multiple issuers thereby preventing the need for said consumers to carry multiple coupon account identifying devices.

5) The electronic coupon system of claim I wherein said electronic coupons may be used as an alternative to rebate coupons by offering an instant price reduction to a consumer that is between the full retail price and the full retail price minus the value of any rebate thereby allowing said consumer to choose between assuming the risk that said consumer may not fulfill the requirements of said rebate and therefore receives no discount and said consumer accepting an instant discount that is smaller than said rebate but said consumer assumes not risk of not receiving said instant discount whereby manufactures of said products can still receive an average price for a batch of said product that is between the full retail price and the full retail price minus any rebate.

6) The electronic coupon system of claim 1 wherein manufacturers and distributors of none store brand products that use said electronic coupon system to distribute coupons benefit from the quandry faced by subscribers of said coupon system who use price as a major deciding factor when purchasing a product who now has to consider similar none store brand products since a none store brand product with an electronic discount coupon could be less expensive than store brand products thereby increasing the likelyhood that said consumer will pruchase a none store brand product.

7) A method whereby a website or television channel or various electronic media displays a list of available discount or rebate coupons in tickertape format.

8) A method whereby a website or television channel or various electronic media displays a list of available discounts or rebates in tickertape format.

9) The electronic coupon system of claim 1 wherein coupon issuers can increase product sales and or brand loyalty in coupon system subscribers by providing a means where said subscribers can contact said coupon issuers through various means to request said issuers issue said subscribers electronic discount coupons to reduce the price of said issuers products thereby making it more competitive with a competitors product that is priced lower or is on sale at a lower price whereby said subscribers will be more willing to purchase said issuers products.
